(19) United States
(12) Patent Application Publication
(10) Pub. No.: US 2020/0369480 A1
(43) Pub. Date: Nov. 26, 2020

(54) UNITIZER AND METHOD OF LOADING A CONTAINER USING THE UNITIZER

(71) Applicant: Signode Industrial Group LLC, Glenview, IL (US)

(72) Inventors: Michael Lee Smith, Greenbrier, AR (US); Curtis Yarbrough, Chattanooga, TN (US); Kelly McGonigal, Malvern, PA (US)

(21) Appl. No.: 16/419,600

(22) Filed: May 22, 2019

(51) Int. Cl. B65G 67/20

(52) U.S. Cl. CPC B65G 67/20; B65D 71/0088

(57) ABSTRACT

Various embodiments of the present disclosure provide a unitizer sized, shaped, and otherwise configured to surround and unitize two vertically stacked palletized loads and a method of loading a shipping container with unitized and non-unitized palletized loads.

### FIELD

The present disclosure relates to unitizers for unitizing vertically stacked palletized loads and methods for loading shipping containers with unitized and non-unitized loads.

### BACKGROUND

In preparation for shipment, products (or boxes containing the products) are positioned on a pallet and secured to the pallet using stretch film (such as by an automated stretch-wrapping machine). This palletized load is then (along with other palletized loads) loaded into a shipping container for transport. Two or three palletized loads are typically stacked atop one another (or “vertically stacked”) within the shipping container to take advantage of available space in the vertical direction so the shipping container can be loaded with as many palletized loads as possible. Dunnage (such as airbags and void filler panels) is often positioned in the voids between the palletized loads and between the palletized loads and the shipping container walls to attempt to limit lateral movement of the palletized loads during transit. But this dunnage rarely prevents all lateral movement of the palletized loads, particularly movement of the loads positioned atop others. This lateral movement of heavy palletized loads can damage the product and make unloading the shipping container difficult and time consuming.

The nature of certain products exacerbates this problem. Roll roofing, which is asphalt matting used as roofing material, is one example product palletized and shipped in the above-described manner Specifically, several rolls of roll roofing are oriented vertically and positioned on and secured to a pallet via stretch film. These palletized loads are loaded into a shipping container and vertically stacked two or three palletized loads high. While these rolls of roll roofing are strong in compression when oriented vertically, that strength significantly decreases once the rolls tilt, which they do during transit. Once the rolls tilt, they lose their strength and begin to buckle, causing the palletized loads to collapse and move around the shipping container. This almost always damages some of the product and makes unloading the shipping container difficult and time consuming. This also increases expenses and environmental waste.

### SUMMARY

Various embodiments of the present disclosure provide a unitizer sized, shaped, and otherwise configured to surround and unitize two vertically stacked palletized loads and a method of loading a shipping container with unitized and non-unitized palletized loads.

One method of loading a shipping container comprises stacking a first palletized load of goods atop a second palletized load of goods to form a first set of palletized loads of goods; unitizing the first set of palletized loads of goods by positioning a first unitizer around the first and second palletized loads of goods; loading the first set of palletized loads of goods into the shipping container; loading a second set of palletized loads of goods into the shipping container adjacent the first set of palletized loads of goods; and positioning dunnage in a void adjacent the first set of palletized loads of goods.

### BRIEF DESCRIPTION OF THE FIGURES

FIG. 1 is a top perspective view of one example unitizer of the present disclosure.

FIG. 2 is a front elevational view of the unitizer of FIG. 1, the back elevational view being a mirror image thereof.

FIG. 3 is a first side elevational view of the unitizer of FIG. 1, the second side elevational view being a mirror image thereof.

FIG. 4 is a top plan view of the unitizer of FIG. 1.

FIG. 5 is a bottom plan view of the unitizer of FIG. 1.

FIG. 6 is a perspective view of the unitizer of FIG. 1 in preparation for installation onto a vertically stacked set of two palletized loads of rolled roofing.

FIG. 7 is a perspective view of the unitizer of FIG. 1 installed onto the vertically stacked set of palletized loads of FIG. 6 to form a unitized vertically stacked set of palletized loads.

FIG. 8A is a diagrammatic top perspective view of a shipping container loaded with unitized and non-unitized vertically stacked sets of palletized loads in accordance with one example method of the present disclosure.

FIG. 8B is a diagrammatic top perspective view of the loaded shipping container of FIG. 8A with individual shrouds positioned over each non-unitized palletized load.

FIG. 9 is a top plan view of FIG. 8B.

### DETAILED DESCRIPTION

While the features, devices, and apparatus described herein may be embodied in various forms, the drawings show and the specification describe certain exemplary and non-limiting embodiments. Not all of the components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as coupled, mounted, connected, and the like, are not intended to be limited to direct mounting methods but should be interpreted broadly to include indirect and operably coupled, mounted, connected and like mounting methods. This specification is intended to be taken as a whole and interpreted in accordance with the principles of the present disclosure and as understood by one of ordinary skill in the art.

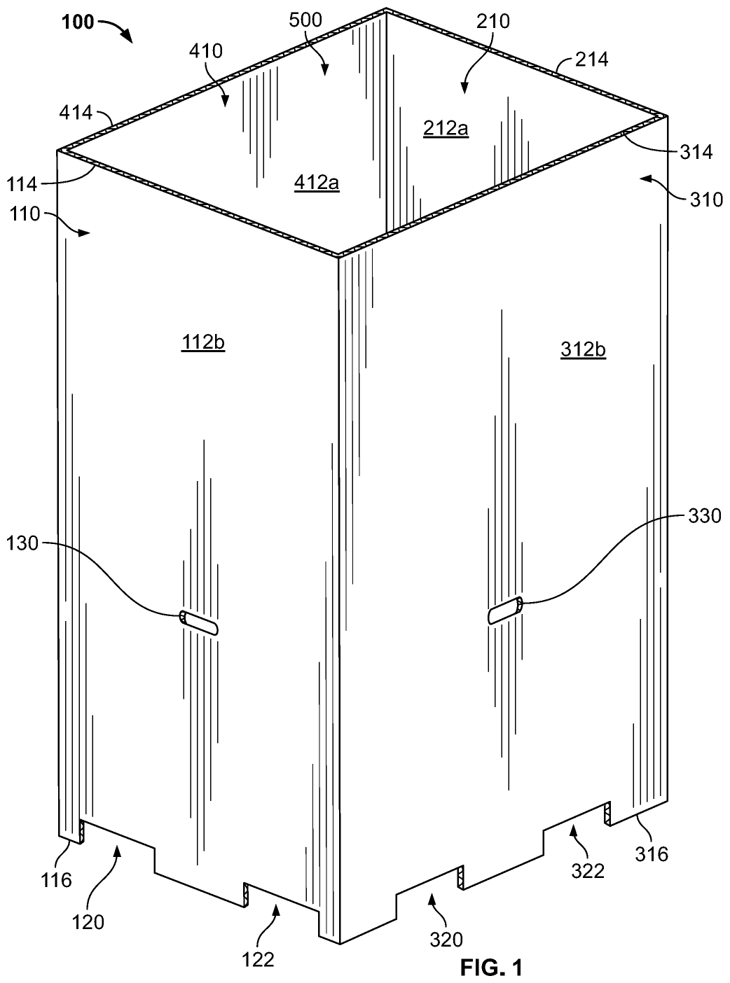

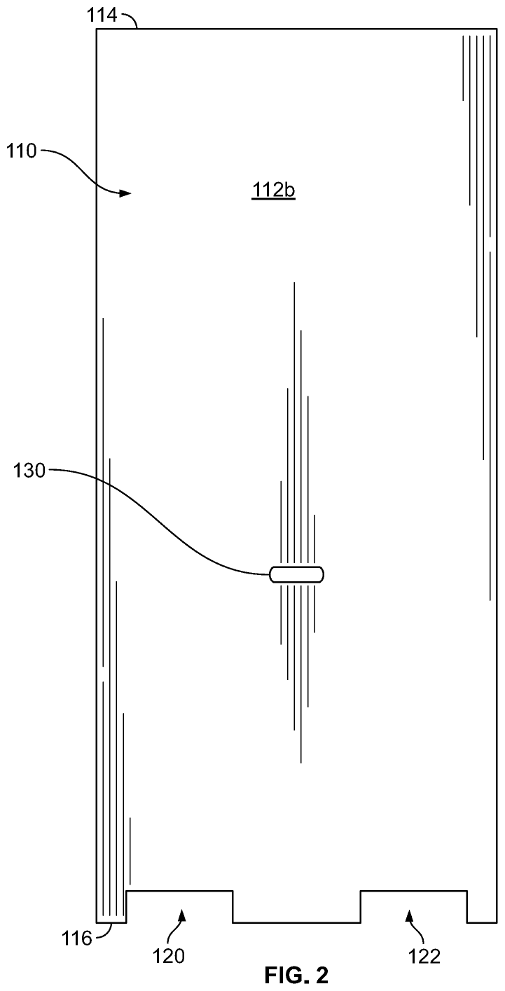

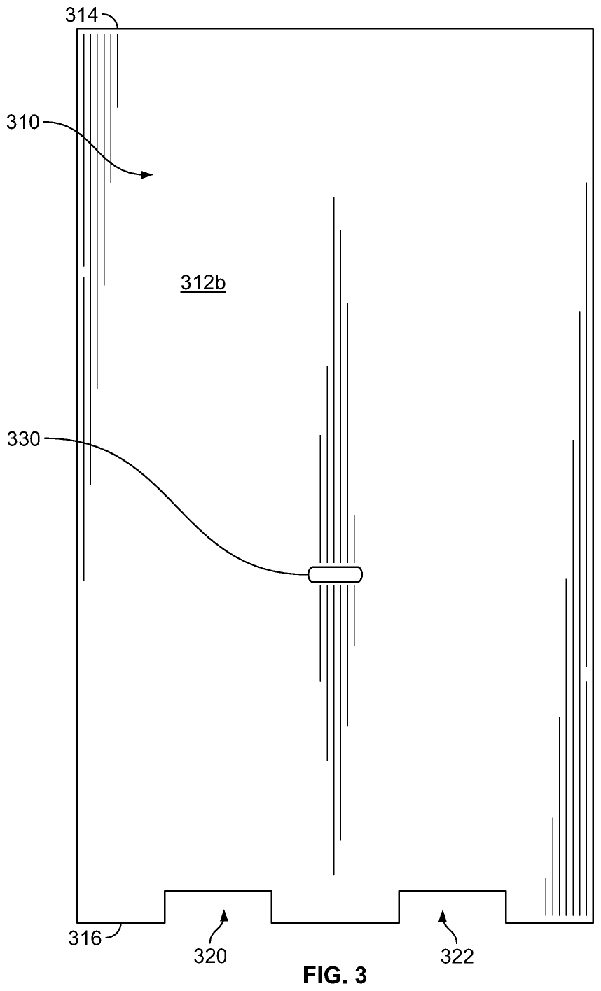

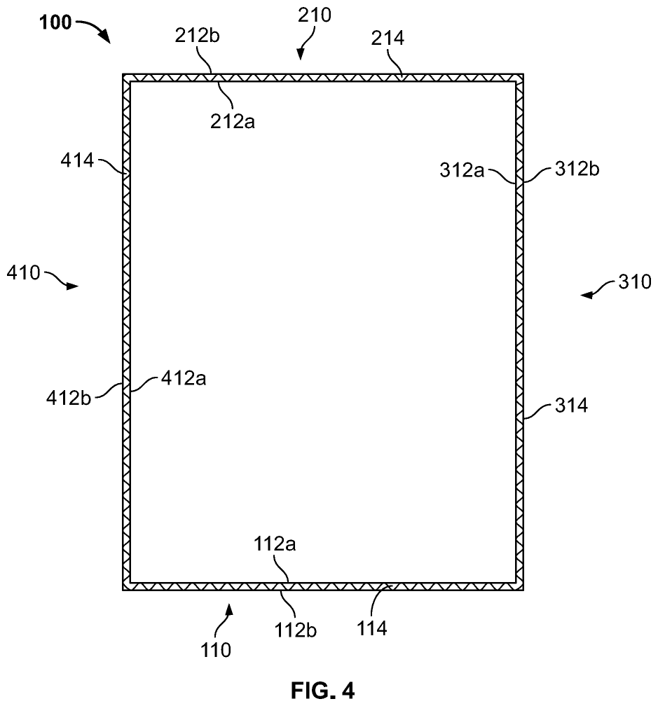

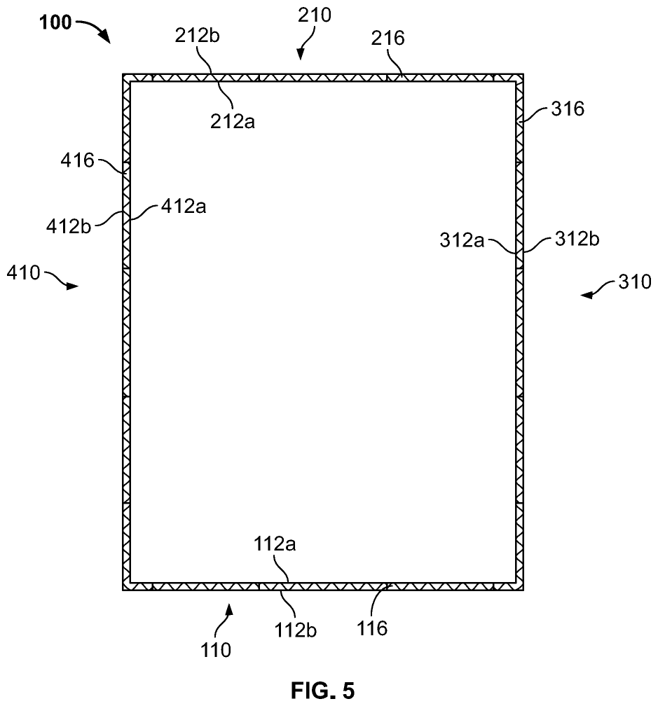

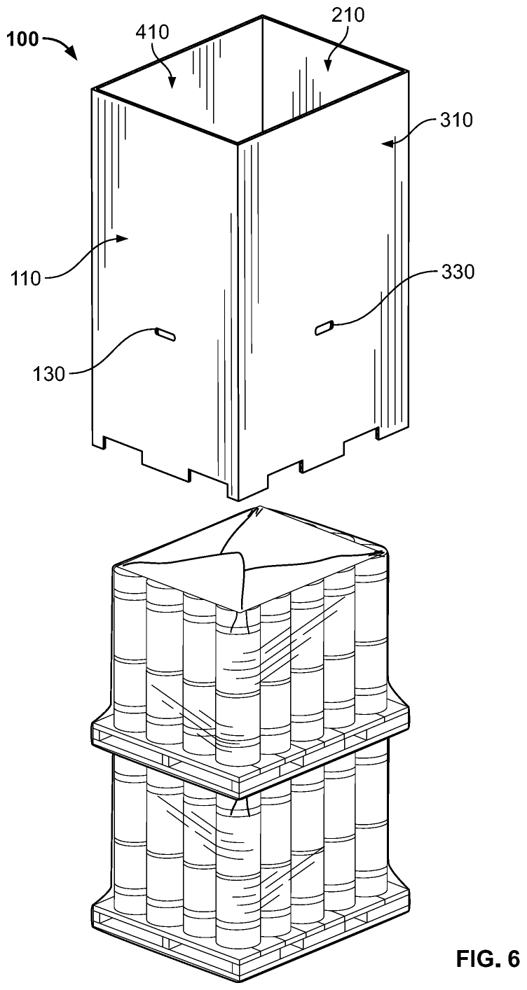

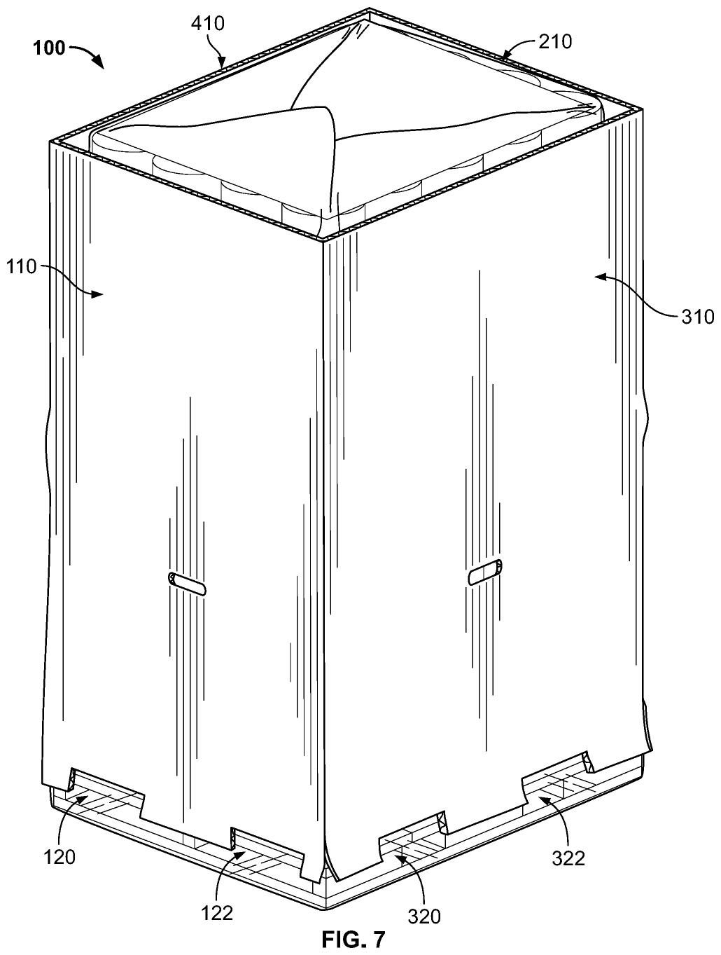

FIGS. 1-7 generally illustrate an example embodiment of a unitizer 100 of the present disclosure. The unitizer 100 is sized, shaped, and otherwise configured to slide over and surround a set of two vertically stacked palletized loads (such as example palletized loads 60 and 70 shown in FIGS. 6 and 7) to unitize them. Once installed, the unitizer 100 constrains the palletized loads in the lateral direction (i.e., transverse to the vertical direction) to minimize lateral movement of the palletized loads relative to one another and to supplement the stretch wrap and further limit the ability of the goods that make up the palletized loads from moving laterally relative to their respective pallets. The unitizer 100 also prevents the top palletized load from falling off of the bottom palletized load (assuming the unitizer 100 does not break and the unitized palletized loads don't tip over). In general, once installed, the unitizer 100 makes the two palletized loads move as one rather than separately.

The unitizer 100 includes: (1) a first (front) upright wall 110; (2) a spaced apart second (back) upright wall 210; (3) a third (side) upright wall 310 extending between and connected to the first wall 110 and the second wall 210; and (4) a fourth (side) upright wall 410 extending between and connected to the first wall 110 and the second wall 210. The walls 110, 210, 310, and 410 define a rectangular tube that defines a central palletized-load-receiving opening 500 sized, shaped, and otherwise configured to receive the set of vertically stacked palletized loads.

In this example embodiment, the first wall 110 includes a planar rectangular first (inner) face 112a, a planer rectangular second (outer) face 112b, a first (top) edge 114, and a second (bottom) edge 116. The first face 112a and the second face 112b face in opposing directions. The first edge 114 is opposite the second edge 116.

In this illustrated example embodiment, the second wall 210 includes a planar rectangular first (inner) face 212a, a planar rectangular second (outer) face 212b, a first (top) edge 214, and a second (bottom) edge 216. The first face 212a and the second face 212b face in opposing directions. The first edge 214 is opposite the second edge 216.

In this illustrated example embodiment, the third wall 310 includes a planar rectangular first (inner) face 312a, a planar rectangular second (outer) face 312b, a first (top) edge 314, and a second (bottom) edge 316. The first face 312a and the second face 312b face in opposing directions. The first edge 314 is opposite the second edge 316.

In this illustrated example embodiment, the fourth wall 410 includes a planar rectangular first (inner) face 412a, a planar rectangular second (outer) face 412b, a first (top) edge 414, and a second (bottom) edge 416. The first face 412a and the second face 412b face in opposing directions. The first edge 414 is opposite the second edge 416.

In this illustrated example embodiment, the second wall 210 is the same shape and size as the first wall 110, and the third wall 310 is the same shape and size as the fourth wall 410. In this illustrated example embodiment, the first wall 110 and the second wall 210 are both approximately 38 inches wide, and the third wall 310 and the fourth wall 410 are both approximately 49 inches wide. In another example embodiment, the first wall 110 is 37 and ⅝ inches wide, the second wall 210 is 38 and ⅛ inches wide, the third wall is 49 and ⅛ inches wide, and the fourth wall is 49 and ⅛ inches wide. In this example embodiment, the first wall 110, the second wall 210, the third wall 310, and the fourth wall 410 are each approximately 84 inches tall. In this illustrated example embodiment, the first wall 110, the second wall 210, the third wall 310, and the fourth wall 410 of the unitizer 100 are slightly shorter than the two vertically stacked palletized loads of rolled roof paper.

In this illustrated example embodiment, the unitizer 100 defines multiple pairs of tine-receiving openings sized, shaped, and otherwise configured to receive the tines of a forklift or pallet jack. More specifically: (1) the wall 110 defines discrete spaced-apart tine receiving openings 120 and 122; (2) the wall 210 defines discrete spaced-apart tine receiving openings (not shown) that mirror openings 120 and 122; (3) the wall 310 defines discrete spaced-apart tine receiving openings 320 and 322; and (4) the wall 410 defines discrete spaced-apart tine receiving openings (not shown) that mirror openings 320 and 322. The quantity, size, position, and configuration of the openings may vary in accordance with the present disclosure, so long as each pair of tine-receiving openings can receive the tines of a forklift or a pallet jack.

In the illustrated embodiment, the openings 120 and 122 vertically extend three inches from the bottom edge 116 of the wall 110. Each opening 120 and 122 is 10 inches wide. The openings 120 and 122 are spaced apart by 12 inches and laterally centered on the bottom edge 116 of the wall 110. The openings defined by the second wall 210 mirror the openings 120 and 122 of the first wall 110 and are not explained in detail.

In the illustrated embodiment, the openings 320 and 322 vertically extend three inches from the bottom edge 316 of the wall 312. Each opening 320 and 322 is 10 inches wide. The openings 320 and 322 are spaced apart by 12 inches from each other and laterally centered on the bottom edge 316 of the wall 312. The openings defined by the fourth wall 410 mirror the openings 320 and 322 of the third wall 310.

The walls 110, 210, 310, and 410 each define a handle opening that has a generally rectangular shape with semicircular ends. Each handle opening functions to assist in installation of the unitizer 100 over a set of two vertically stacked palletized loads. More specifically: (1) the wall 110 defines a handle opening 130; (2) the wall 210 defines a handle opening (not shown) that mirrors the handle opening 130; (3) the wall 310 defines a handle opening 330; and (4) the wall 410 defines a handle opening (not shown) that mirrors the handle opening 330. The quantity, size, position, and configuration of the handle openings may vary in accordance with the present disclosure. In other embodiments, fewer than all of the walls define handle openings. For instance, in one embodiment, only two opposing walls define handle openings which the other two do not.

In the illustrated embodiment, the first handle opening 130 is positioned 32 inches from the bottom edge 116 of the first wall 110. The other three handle openings corresponding to the second wall 210, third wall 310, and fourth wall 410 are also 32 inches from the bottom edge of each respective wall.

In this illustrated example embodiment, each of the first, second, third, and fourth walls are made from a generally planar corrugated panel, such as a 275 lb. test double-wall corrugated panel. These walls can be made from other suitable materials in accordance with the present disclosure such as, but not limited to, a 275 lb. test single-wall corrugated panel or a 1,100 lb. test triple-wall corrugated panel. In other embodiments, one or more of the walls can be made from other suitable panels, such as honeycomb panel structures.

In this illustrated example embodiment, the first wall 110 is connected to the fourth wall 410 by a suitable adhesive (not shown). More specifically, the fourth wall 410 includes a 4 inch overlapping strip extending from the bottom edge 416 to the top edge 414 along one side of the fourth wall 410. The overlapping strip folds at an approximately 90 degree angle to contact the first wall 110. Adhesive is placed on the overlapping strip and/or a portion of the first wall 110 that contacts the overlapping strip, so a rectangular tube is formed as shown in FIGS. 1-7. Vertical creases are formed where the walls join one another so the unitizer 100 may be folded relatively flat (at two opposing creases) for storage and transport.

FIGS. 6 and 7 illustrate the unitizer 100 being employed to unitize a set of two vertically stacked palletized loads 60 and 70. As shown in FIG. 6, an installer positions the unitizer 100 over the set of vertically stacked palletized loads 60 and 70 so the palletized-load-receiving opening 500 is positioned above the palletized loads 60 and 70. The installer then moves the unitizer 100 downward so the palletized-load-receiving opening 500 receives the palletized loads 60 and 70 and so the bottom edges of the walls of the unitizer 100 contact (or are adjacent to) the pallet of the bottom palletized load, as best shown in FIG. 7. After installation, in this embodiment portions of the walls near the bottom edges of the walls (i.e., the portions separated by tine-receiving openings) flare outward upon contacting the pallet, though they may not in other embodiments. This friction fit ensures that the unitizer 100 remains on the palletized loads.

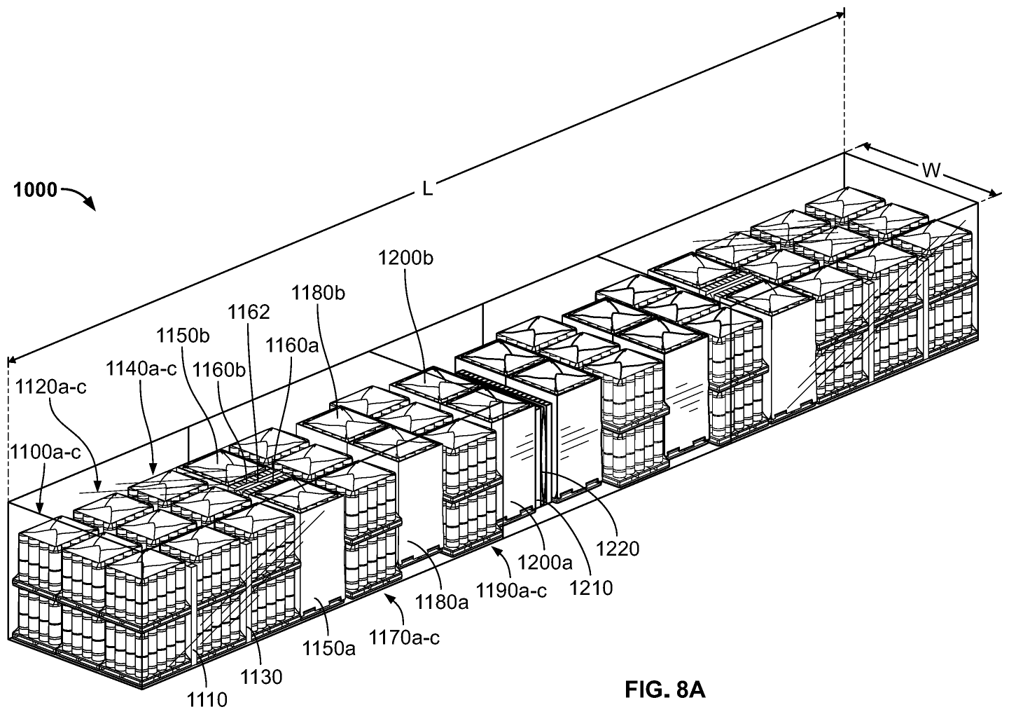

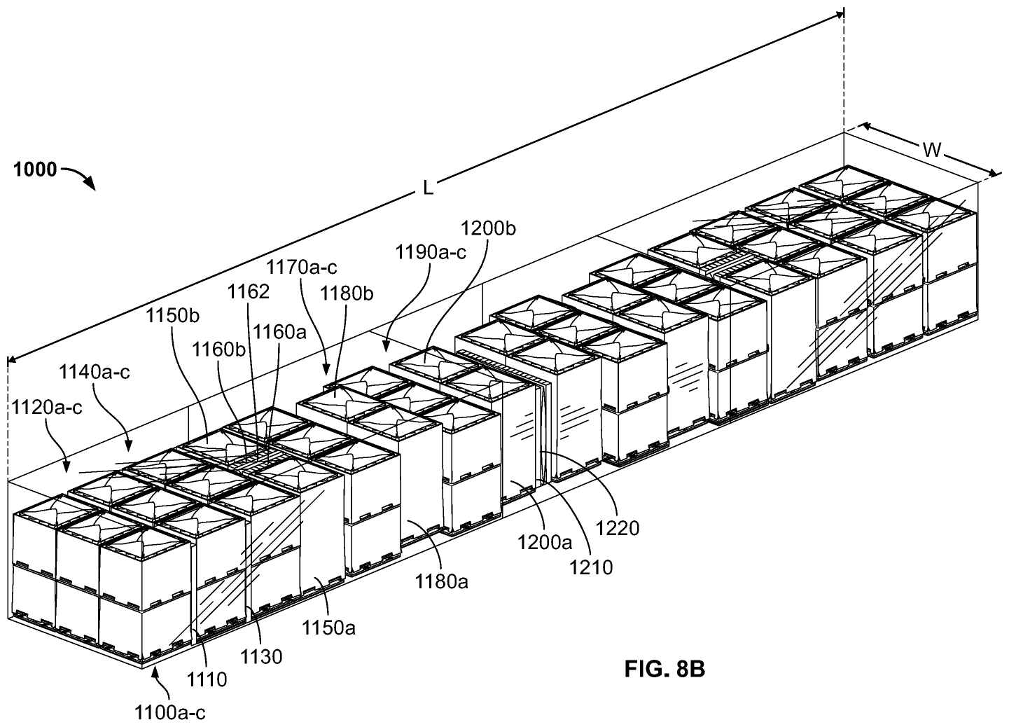

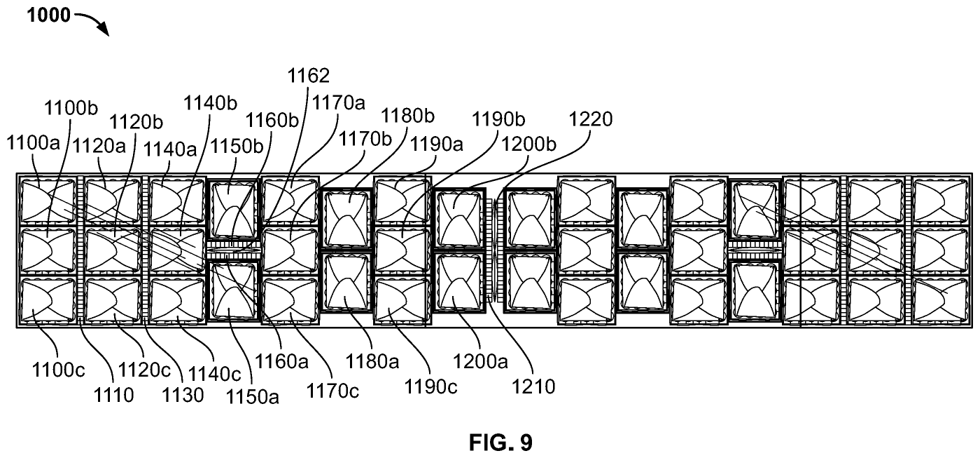

FIGS. 8A, 8B, and 9 generally illustrate the floor and walls of a shipping container 1000 (such as a freight railroad car) having an interior compartment defined by opposing first and second end walls, opposing first and second side walls, and a floor and an opposing ceiling. A side door (not shown) in one of the side walls provides access to the interior compartment. The shipping container 1000 has a length L and a width W. FIGS. 8A, 8B, and 9 illustrate the shipping container 1000 loaded with multiple unitized and non-unitized vertically stacked sets of palletized loads in accordance with one method of the present disclosure. Each stacked vertically stacked set of palletized loads (sometimes referred to as a “set of palletized loads”), whether unitized with a unitizer 100 or not, includes a bottom palletized load and a top palletized load atop the bottom palletized load. When viewed from above (as shown in FIG. 9), each set of palletized loads includes opposing first and second short sides that form a width of the set of palletized loads and opposing first and second long sides that form a length of the set of palletized loads. In this example embodiment, the length of the set of palletized loads is greater than the width of the set of palletized loads (though this may be swapped or the length and width may be equal in other embodiments).

One example embodiment of the method of loading the shipping container 1000 generally includes, for a first end of the container 1000: (1) loading a first group of non-unitized sets of palletized loads 1100a, 1100b, and 1100c; then (2) loading first dunnage 1110; then (3) loading a second group of non-unitized sets of palletized loads 1120a, 1120b, and 1120c; then (4) loading second dunnage 1130; then (5) loading a third group of non-unitized sets of palletized loads 1140a, 1140b, and 1140c; then (6) loading a first group of unitized sets of palletized loads 1150a and 1150b; then (7) loading third dunnage 1160a, 1160b, and 1162 between the unitized sets of palletized loads 1150a and 1150b of the first group of unitized sets of palletized loads; then (8) loading a fourth group of non-unitized sets of palletized loads 1170a, 1170b, and 1170c; then (9) loading a second group of unitized sets of palletized loads 1180a and 1180b; then (10) loading a fifth group of non-unitized sets of palletized loads 1190a, 1190b, and 1190c; then (11) loading a third group of unitized sets of palletized loads 1200a and 1200b; and then (12) loading fourth dunnage 1210. This example method also includes (13) repeating steps 1-12 for the second end of the container 1000. This example method further includes (14) loading additional dunnage 1220 between the fourth dunnage 1210 in the first end of the container and the corresponding last-to-be-loaded dunnage in the second end of the container. For brevity, these 14 steps of this example embodiment are referred to as loading method steps 1-14, respectively.

More specifically, loading method step 1 includes loading the first group of non-unitized sets of palletized loads 1100a, 1100b, and 1100c into the first end of the container 1000 so the first short side of each non-unitized set of palletized loads 1100a, 1100b, and 1100c faces the end wall of the container 1000, i.e., so each non-unitized set of palletized loads 1100a, 1100b, and 1100c is oriented with its width aligned with the width direction of the container 1000 and its length aligned with the length direction of the container 1000. This may vary in other embodiments of the present disclosure. The first long side of the non-unitized set of palletized loads 1100a faces the first side wall of the container 1000. The second long side of the non-unitized set of palletized loads 1100a faces the first long side of the non-unitized set of palletized loads 1100b. The second long side of the non-unitized set of palletized loads 1100b faces the first long side of the non-unitized set of palletized loads 1100c. The second long side of the non-unitized set of palletized loads 1100c faces the second side wall of the container 1000. The non-unitized sets of palletized loads 1100a, 1100b, and 1100c are generally aligned with one another across the width of the container 1000.

Loading method step 2 includes loading the first dunnage 1110 into the container 1000. The first dunnage 1110 includes a first face and an opposing second face. The first face faces (and in some instances contacts) the second short sides of the non-unitized sets of palletized loads 1100a, 1100b, and 1100c and is oriented so it extends across the width of the container 1000 and is perpendicular to the length direction of the container 1000. The first dunnage 1110 extends from a floor of the container 1000 to the top of the non-unitized sets of palletized loads 1100a, 1100b, and 1100c. Here, the first dunnage 1110 includes three honeycomb void filler panels that are 48 inches×84 inches×4 inches and positioned side by side across the width of the container 1000, though any suitable type and any suitable quantity of dunnage that collectively extends across the width of the container 1000 may be employed.

Loading method step 3 includes loading the second group of non-unitized sets of palletized loads 1120a, 1120b, and 1120c into the first end of the container 1000 so the first short side of each non-unitized set of palletized loads 1120a, 1120b, and 1120c faces the second face of the first dunnage 1110, i.e., so each non-unitized set of palletized loads 1120a, 1120b, and 1120c is oriented with its width aligned with the width direction of the container 1000 and its length aligned with the length direction of the container 1000. The first long side of non-unitized set of palletized loads 1120a faces the first side wall of container 1000. The second long side of non-unitized set of palletized loads 1120a faces the first long side of non-unitized set of palletized loads 1120b. The second long side of non-unitized set of palletized loads 1120b faces the first long side of non-unitized set of palletized loads 1120c. The second long side of non-unitized set of palletized loads 1120c faces the second side wall of the container 1000. The non-unitized sets of palletized loads 1120a, 1120b, and 1120c are generally aligned with one another across the width of the container 1000.

Loading method step 4 includes loading the second dunnage 1130 into the container 1000. The second dunnage 1130 includes a first face and an opposing second face. The first face faces (and in some instances contacts) the second short side of each of the non-unitized sets of palletized loads 1120a, 1120b, and 1120c and is oriented so it extends across the width of the container 1000 and is perpendicular to the length of the container 1000. The second dunnage 1130 extends from the floor of the container 1000 to the top of the non-unitized sets of palletized loads 1120a, 1120b, and 1120c. Here, the second dunnage 1130 includes three honeycomb panels that are 48 inches×84 inches×4 inches and positioned side by side across the width of the container 1000, though any suitable type and any suitable quantity of dunnage that collectively extends across the width of the container 1000 may be employed.

Loading method step 5 includes loading the third group of non-unitized sets of palletized loads 1140a, 1140b, and 1140c into the first end of the container 1000 so the first short side of each non-unitized set of palletized loads 1140a, 1140b, and 1140c faces the second face of the second dunnage 1130, i.e., so each non-unitized set of palletized loads 1140a, 1140b, and 1140c is oriented with its width aligned with the width direction of the container 1000 and its length aligned with the length direction of the container 1000. The first long side of non-unitized set of palletized loads 1140a faces the first side wall of the container 1000. The second long side of non-unitized set of palletized loads 1140a faces the first long side of non-unitized set of palletized loads 1140b. The second long side of non-unitized set of palletized loads 1140b faces the first long side of non-unitized set of palletized loads 1140c. The second long side of non-unitized set of palletized loads 1140c faces the second side wall of the container 1000. The non-unitized sets of palletized loads 1140a, 1140b, and 1140c are generally aligned with one another across the width of the container 1000.

Loading method step 6 includes loading the first group of unitized sets of palletized loads 1150a and 1150b into the first end of the container 1000 so the first long side of each unitized set of palletized loads 1150a and 1150b faces the second short sides of the non-unitized sets of palletized loads 1140a, 1140b, and 1140c, i.e., so each unitized set of palletized loads 1150a and 1150b is oriented with its width aligned with the length direction of the container 1000 and its length aligned with the width direction of the container 1000. The first short side of unitized set of palletized loads 1150a faces the second side wall of the container 1000. The first short side of unitized set of palletized loads 1150b faces the first side wall of the container 1000. The second short side of unitized set of palletized loads 1150a faces the second short side of unitized set of palletized loads 1150b. The unitized sets of palletized loads 1150a and 1150b are generally aligned with one another across the width of the container 1000.

Loading method step 7 includes loading third dunnage 1160a, 1160b, and 1162 into the container 1000. The third dunnage 1160a and 1160b are void filers each including a first face and a second face. The first face of each void filler 1160a and 1160b contacts the second short side of each of the unitized sets of palletized loads 1150a and 1150b respectively. The void fillers 1160a and 1160b extend in the length direction of the container 1000, parallel to the second short sides of the unitized sets of palletized loads 1150a and 1150b. The void fillers 1160a and 1160b extend from the floor of the container 1000 to the top of the unitized sets of palletized loads 1150a and 1150b. Here, the void fillers 1160a and 1160b are 36 inches×84 inches×4 inches, though any suitable type and any suitable quantity of dunnage may be employed. The third dunnage 1162 includes a dunnage air bag, and loading method step 7 includes positioning the dunnage air bag 1162 between the void fillers 1160a and 1160b and inflating the dunnage air bag to a desired pressure to fill the void between the void fillers 1160a and 1160b.

Loading method step 8 includes loading the fourth group of non-unitized sets of palletized loads 1170a, 1170b, and 1170c into the first end of the container 1000 so the first short side of each non-unitized set of palletized loads 1170a, 1170b, and 1170c faces the second long sides of the unitized sets of palletized loads 1150a and 1150b, i.e., so each non-unitized set of palletized loads 1150a, 1150b, and 1150c is oriented with its width aligned with the width direction of the container 1000 and its length aligned with the length direction of the container 1000. The first long side of non-unitized set of palletized loads 1170a faces the first side wall of the container 1000. The second long side of non-unitized set of palletized loads 1170a faces the first long side of non-unitized set of palletized loads 1170b. The second long side of non-unitized set of palletized loads 1170b faces the first long side of non-unitized set of palletized loads 1170c. The second long side of non-unitized set of palletized loads 1170c faces the second side wall of the container 1000. The non-unitized sets of palletized loads 1170a, 1170b, and 1170c are generally aligned with one another across the width of the container 1000.

Loading method step 9 includes loading the second group of unitized sets of palletized loads 1180a and 1180b into the first end of the container 1000 so the first long side of each unitized set of palletized loads 1180a and 1180b faces the second short sides of the non-unitized sets of palletized loads 1170a, 1170b, and 1170c, i.e., so each unitized set of palletized loads 1180a and 1180b is oriented with its width aligned with the length direction of the container 1000 and its length aligned with the width direction of the container 1000. The first short side of unitized set of palletized loads 1180a faces the second side wall of the container 1000. The first short side of unitized set of palletized loads 1180b faces the first side wall of the container 1000. The second short side of unitized set of palletized loads 1180a faces the second short side of unitized set of palletized loads 1180b. The unitized sets of palletized loads 1180a and 1180b are centered in the width direction of the container 1000 so voids exist between the side walls of the container 1000 and the respective unitized sets of palletized loads 1180a and 1180b. In certain embodiments, dunnage is positioned in those voids.

Loading method step 10 includes loading the fifth group of non-unitized sets of palletized loads 1190a, 1190b, and 1190c into the first end of the container 1000 so the first short side of each non-unitized set of palletized loads 1190a, 1190b, and 1190c faces the second long sides of the unitized sets of palletized loads 1180a and 1180b, i.e., so each non-unitized set of palletized loads 1190a, 1190b, and 1190c is oriented with its width aligned with the width direction of the container 1000 and its length aligned with the length direction of the container 1000. The first long side of non-unitized set of palletized loads 1190a faces the first side wall of the container 1000. The second long side of non-unitized set of palletized loads 1190a faces the first long side of non-unitized set of palletized loads 1190b. The second long side of non-unitized set of palletized loads 1190b faces the first long side of non-unitized set of palletized loads 1190c. The second long side of non-unitized set of palletized loads 1190c faces the second side wall of the container 1000. The non-unitized sets of palletized loads 1190a, 1190b, and 1190c are generally aligned with one another across the width of the container 1000.

Loading method step 11 includes loading the third group of unitized sets of palletized loads 1200a and 1200b into the first end of the container 1000 so the first long side of each unitized set of palletized loads 1200a and 1200b faces the second short sides of the non-unitized sets of palletized loads 1190a, 1190b, and 1190c, i.e., so each unitized set of palletized loads 1200a and 1200b is oriented with its width aligned with the length direction of the container 1000 and its length aligned with the width direction of the container 1000. The first short side of unitized set of palletized loads 1200a faces the second side wall of the container 1000. The first short side of unitized set of palletized loads 1200b faces the first side wall of the container 1000. The second short side of unitized set of palletized loads 1200a faces the second short side of unitized set of palletized loads 1200b. The unitized sets of palletized loads 1200a and 1200b are centered in the width direction of the container 1000 so voids exist between the side walls of the container 1000 and the respective unitized sets of palletized loads 1200a and 1200b. In certain embodiments, dunnage is positioned in those voids.

Loading method step 12 includes loading the fourth dunnage 1210 into the container 1000. The fourth spacer 1210 includes a first face and a second face. The first face contacts the second long side of each of the unitized sets of palletized loads 1200a and 1200b. The fourth dunnage 1210 extends across width of the container 1000 perpendicular to the length L of the container 1000. The fourth dunnage 1210 extends from the floor of the container 1000 to the top of the unitized sets of palletized loads 1200a and 1200b. Here, the fourth dunnage 1220 includes two honeycomb panels that are 48 inches×84 inches×4 inches, positioned side by side across the second long sides of the unitized sets of palletized loads 1200a and 1200b. A single spacer may be used instead, so the single spacer extends across the second long sides of the unitized sets of palletized loads 1200a and 1200b.

Loading method step 13 includes repeating steps 1-12 for the second end of the container 1000 (i.e., the right side as shown in FIGS. 8A, 8B, and 9). The opposing sides of the container 1000 may be loaded simultaneously or separately. For example, the method of loading container 1000 can include alternately loading groups of sets of palletized loads into the opposing sides of the container 1000. At bottom, loading method step 13 may be completed before, after, or commensurate with completion of loading method steps 1-12.

In this example embodiment, loading method steps 1-12 are completed for the first end of container 1000 in the order written above, though in other embodiments the loading method steps may be completed in a different order.

Loading method step 14 includes loading additional dunnage 1220—here, a dunnage air bag—into the container 1000. Specifically, this step includes positioning the dunnage air bag 1220 between the fourth dunnage 1210 and its counterpart on the second end of the container 1000 and then inflating the dunnage air bag 1220 to a desired pressure. The dunnage 1220 may include any suitable quantity of any suitable dunnage.

The method includes loading palletized goods either manually, semi-manually, or automatically. The palletized goods are loaded and/or unloaded with the use of one or more forklifts, pallet jacks, or other suitable equipment.

By employing multiple strategically-placed unitizers 100 and the positioning methods of the present disclosure, additional palletized loads can be stably stacked and positioned in such containers as compared with prior art methods that do not employ the unitizers. This substantially increases the payload of these freight railroad cars without increasing product loss. For example, for a conventional fifty foot six inch boxcar, the unitizers of the present disclosure facilitate and increase to 84 pallets while still being within maximum weight limits for this freight railroad car. This provides substantial fuel, time, and shipping expense savings, while also limiting the risk of product shifting and/or product loss during transit, loading, and unloading.

The present disclosure also includes a shipping container (such a freight railroad car) loaded with these components described above in the manner described above.

Various changes and modifications to the presently preferred embodiments described herein will be apparent to those skilled in the art. These changes and modifications can be made without departing from the spirit and scope of the present subject matter and without diminishing its intended advantages. It is intended that such changes and modifications be covered by the appended claims.

1. A method of loading a shipping container, the method comprising:
stacking a first palletized load of goods atop a second palletized load of goods to form a first set of palletized loads of goods;
unitizing the first set of palletized loads of goods by positioning a first unitizer around the first and second palletized loads of goods;
loading the first set of palletized loads of goods into the shipping container;
loading a second set of palletized loads of goods into the shipping container adjacent the first set of palletized loads of goods; and
positioning dunnage in a void adjacent the first set of palletized loads of goods.

2. The method of claim 1, wherein the second set of palletized loads of goods comprises a third palletized load of goods stacked atop a fourth palletized load of goods.

3. The method of claim 2, further comprising unitizing the second set of palletized loads of goods by positioning a second unitizer around the third and fourth palletized loads of goods.

4. The method of claim 1, further comprising:
(1A) loading a first group of multiple non-unitized sets of palletized loads of goods into a first end of the shipping container;
(2A) loading a second group of multiple non-unitized sets of palletized loads of goods into the first end of the shipping container;
(3A) positioning first dunnage between the first and second groups of non-unitized sets of palletized loads of goods;
(4A) loading a third group of multiple non-unitized sets of palletized loads of goods into the first end of the shipping container;
(5A) positioning second dunnage between the second and third groups of non-unitized sets of palletized loads of goods;
(6A) loading a first group of multiple unitized sets of palletized loads of goods into the first end of the shipping container;
(7A) positioning third dunnage between the unitized sets of palletized loads of goods of the first group of unitized sets of palletized loads of goods;
(8A) loading a fourth group of multiple non-unitized sets of palletized loads of goods into the first end of the shipping container;
(9A) loading a second group of multiple unitized sets of palletized loads of goods into the first end of the shipping container;
(10A) loading a fifth group of multiple non-unitized sets of palletized loads of goods into the first end of the shipping container; and
(11A) loading a third group of multiple unitized sets of palletized loads of goods into the first end of the shipping container,
wherein the first set of palletized loads of goods is one of the first group of unitized sets of palletized loads of goods,
wherein the third dunnage comprises the dunnage,
wherein the second set of palletized loads of goods is one of the fourth group of non-unitized sets of palletized loads of goods.

5. The method of claim 4, wherein the third dunnage comprises at least one of: a dunnage airbag and a honeycomb void filler.

6. The method of claim 4, further comprising:
(1B) loading a sixth group of multiple non-unitized sets of palletized loads of goods into a second end of the shipping container;
(2B) loading a seventh group of multiple non-unitized sets of palletized loads of goods into the second end of the shipping container;
(3B) positioning fourth dunnage between the sixth and seventh groups of non-unitized sets of palletized loads of goods;
(4B) loading an eighth group of multiple non-unitized sets of palletized loads of goods into the second end of the shipping container;
(5B) positioning fifth dunnage between the seventh and eighth groups of non-unitized sets of palletized loads of goods;
(6B) loading a fourth group of multiple unitized sets of palletized loads of goods into the second end of the shipping container;
(7B) positioning fifth dunnage between the unitized sets of palletized loads of goods of the fourth group of unitized sets of palletized loads of goods;
(8B) loading a ninth group of multiple non-unitized sets of palletized loads of goods into the second end of the shipping container;
(9B) loading a fifth group of multiple unitized sets of palletized loads of goods into the second end of the shipping container;
(10B) loading a tenth group of multiple non-unitized sets of palletized loads of goods into the second end of the shipping container; and
(11B) loading a sixth group of multiple unitized sets of palletized loads of goods into the second end of the shipping container.

7. The method of claim 6, further comprising, after performing steps 1A-11A and 1B-11B, positioning sixth dunnage between the third and sixth groups of unitized sets of palletized loads of goods.

8. The method of claim 4, further comprising loading the groups of unitized and non-unitized sets of palletized loads of goods into the first end of the shipping container in the following order: the first group or non-unitized sets of palletized loads of goods, the second group of non-unitized sets of palletized loads of goods, the third group of non-unitized sets of palletized loads of goods, the first group of unitized sets of palletized loads of goods, the fourth group of non-unitized sets of palletized loads of goods, the second group of unitized sets of palletized loads of goods, the fifth group of non-unitized sets of palletized loads of goods, and the third group of unitized sets of palletized loads of goods.

9. The method of claim 4, wherein the shipping container has a length direction and a width direction, wherein the third and fourth groups of non-unitized sets of palletized loads of goods each comprise three non-unitized sets of palletized loads of goods that extend across the shipping container in the width direction, wherein the first group of unitized sets of palletized loads of goods comprises two unitized sets of palletized loads of goods that extend across the shipping container in the width direction.

10. The method of claim 1, wherein the shipping container has a length direction and a width direction, the method further comprising:
loading eight groups of multiple sets of palletized loads of goods into a first end of the shipping container, wherein each set of palletized loads of goods has a length and a width, wherein the eight groups comprise:
five groups of multiple non-unitized sets of palletized loads of goods each oriented with its length and width respectively aligned with the length and width direction of the shipping container; and
three groups of multiple unitized sets of palletized loads of goods each oriented with its length and width respectively aligned with the width and length direction of the shipping container;
wherein the first set of palletized loads of goods is one of the five groups of unitized sets of palletized loads of goods,
wherein the second set of palletized loads of goods is one of the three groups of non-unitized sets of palletized loads of goods.

11. The method of claim 10, wherein each group of unitized sets of palletized loads of goods is adjacent to a group of non-unitized sets of palletized loads of goods.

12. The method of claim 11, wherein:
two of the groups of two unitized sets of palletized loads of goods are adjacent to two of the groups of sets of palletized loads of goods, and
the third group of unitized sets of palletized loads of goods is adjacent to one of the groups of sets of palletized loads of goods.

13. The method of claim 10, further comprising loading void fillers between at least two pairs of adjacent sets of palletized loads of goods, wherein one of the void fillers comprises the dunnage.

14. The method of claim 10, further comprising loading dunnage between two unitized sets of palletized loads of goods of one of the groups of unitized sets of palletized loads of goods.

15. The method of claim 1, further comprising positioning the dunnage before loading the second set of palletized loads of goods.
